(19) United States
(12) Patent Application Publication
(10) Pub. No.: US 2025/0103403 A1
(43) Pub. Date: Mar. 27, 2025

(54) System and Method for Generating Notifications with Customized Event Architectures

(71) Applicant: The Toronto-Dominion Bank, Toronto (CA)

(72) Inventors: Peter KONDILIS, Toronto (CA); Victor MAO, Markham (CA); Eujin ONG, Toronto (CA); Thomas BIANCHI, Toronto (CA); Jason Kim Kang TRANG, Ottawa (CA); George Elias Ibrahim GOUEL, Montreal (CA); Ranjith JEYABALAN, Pickering (CA)

(73) Assignee: The Toronto-Dominion Bank, Toronto, ON (CA)

(21) Appl. No.: 18/474,416

(22) Filed: Sep. 26, 2023

(51) Int. Cl. G06F 9/54

(52) U.S. Cl. CPC G06F 9/542

(57) ABSTRACT

A system, device and method are provided for assessing actions of authenticated persons within an enterprise system. The illustrative method includes providing an application for processing a workflow with services a database for each service. The method includes configuring each of the services to write events to respective databases. Each database can have a dedicated outbox table of events for that service. The method includes, with an event platform: configuring a connector for consuming events to process events in the dedicated outbox tables and determining one or more subscription topics associated with the processed events. The method includes, based on the one or more determined subscription topics, generating, and transmitting one or more notifications, and posting transmission of the one or more notifications to another topic, the other topic being associated with the determined one or more topics.

### TECHNICAL FIELD

The following relates generally to digital event architectures, and more particularly to generating notifications with customized event architectures.

### BACKGROUND

A variety of digitized processes exist where stakeholders have limited insight to the process. For businesses, a lack of transparency can lead to customer frustration, as the operator of the process is unable to provide information which a customer may feel should be available.

From a technical perspective, the lack of transparency regarding processes that are controlled by the organization to entities within that organization can be a result of: (1) legacy architecture which would be too costly to adapt, or does not have the ability to change to meet the transparency requirements, (2) practices which encourage siloing of data as a means to ensuring security, (3) the difficulty in generating a scalable, robust, and flexible system that can engage with multiple different data sources for different purposes.

The lack of transparency can also result from the difficulty in maintaining the required computer architecture. Maintenance can be demanding, and systems which are poorly maintained can be worse than non-existent systems in that they can provide inaccurate information.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example workflow for generating notifications with customized event architectures, as disclosed herein.

FIGS. 3A, 3B 3C, and 3C are each a block diagram of an example aspect of a workflow for generating notifications with customized event architectures, as disclosed herein.

FIG. 4 is a block diagram of an example configuration of a cloud computing platform according to the disclosure herein.

FIG. 5 is a block diagram of an example configuration of an enterprise platform.

FIG. 6 is a block diagram of an example configuration of an entity device.

FIG. 7 is a flow diagram of an example method performed by computer executable instructions for generating notifications with customized event architectures.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

In at least some existing approaches discussed above, event architectures are configured to have information provided to a single outbox table. The event platform thereafter processes the single outbox table to process events. In these applications, the outbox table can result in poor accuracy; the applications cannot guarantee that outbox table events will be recorded successfully as part of an event transaction. The outbox table approach can create undesirable complexity to manage failures and/or reties to save event data if a service and/or database is not available.

The disclosed customized event structure can include applications that provide products or services (or services associated with these applications) being provided with a dedicated outbox table. The dedicated outbox table, managed by the relevant application or service, can be used to ensure the accuracy of any event stored therein.

The outbox tables can be in communication with an event platform (e.g., via a connector) that consumes events therein. In example embodiments, the event platform can be configured such that the respective application or service is assigned to a particular workflow, and events consumed from assigned applications are therefore ensured to be routed to the correct workflow in the event that the event is successfully consumed (in contrast to other approaches where an event may be consumed but misattributed).

The event platform can be used to route the events to subscribed downstream services. These downstream services generate notifications that comply with one or more notification criteria (e.g., whether the event is an expiry event, whether a new promotion is available, whether a particular product offering is being purged, whether an application has been approved, etc.).

The disclosed structure can include a database which stores information about expiring events. This database can be periodically queried to determine new notification events for the existing notification architecture, potentially enabling a robust expiry tracking mechanism. In addition, once the new architecture is established with the outbox tables, event platform, and downstream services, the system can be used to retrofit existing events that would otherwise qualify for notifications by generating events for the service which controls the respective outbox.

In one aspect, a system for generating notifications with customized event architectures is disclosed. The system includes a processor, a communications module coupled to the processor, and a memory coupled to the processor. The memory stores computer executable instructions that when executed by the processor cause the processor to provide one or more applications, each application for processing a respective workflow with one or more services, and provide, for each service associated with the one or more applications, a database. The instructions cause the processor to configure each of the one or more services to write events to respective databases. Each database can have a dedicated outbox table of events for that service. The instructions cause the processor to, with an event platform, configure a connector for consuming events to process events in the dedicated outbox tables, and determine one or more subscription topics associated with the processed events. The instructions cause the processor to, based on the one or more determined subscription topics, generate, and transmit one or more notifications, and post transmission of the one or more notifications to another topic, the other topic being associated with the determined one or more topics.

In example embodiments, the instructions cause the processor to query a database storing data associated with expiring events to determine whether the consumed event satisfies one or more criteria, generate a new notification event in response to the one or more criteria being satisfied, and process the new notification event to generate the one or more notifications with the event platform. In example embodiments, the database for generating events related to expiry is located on a cloud computing server separate from the event platform.

In example embodiments, to generate and transmit the one or more notifications, the instructions cause the processor to determine whether one or more notification criteria are satisfied and generate the one or more notifications in response to the notification criteria being satisfied.

In example embodiments, the instructions cause the processor to determine that at least some existing events associated of at least one of the one or more applications requires retrofitting and generate new events for the determined at least some existing events and post the new events to the respective outbox table for processing.

In example embodiments, at least two of the plurality of services generate events based on a single application of the one or more applications.

In example embodiments, the generated notification is generated by a notification service separate from the event platform.

In example embodiments, each of the one or more services is configured to independently post to the dedicated outbox table.

In example embodiments, the instructions cause the processor to, with an event service associated with the determined subscription topic: query an enterprise database for notification information and populate the one or more notifications with responses to the query.

The event service can be implemented on a remote computing environment, and the enterprise database can be implemented on a private cloud of the enterprise.

In another aspect, a method for generating notifications with customized event architectures is disclosed. The method includes providing a one or more applications, each application for processing a respective workflow with one or more services, and providing, for each service associated with the one or more applications, a database. The method includes configuring each of the one or more services to write events to respective databases. Each database can have a dedicated outbox table of events for that service. The method includes, with an event platform: configuring a connector for consuming events to process events in the dedicated outbox tables and determining one or more subscription topics associated with the processed events. The method includes, based on the one or more determined subscription topics, generating, and transmitting one or more notifications, and posting transmission of the one or more notifications to another topic, the other topic being associated with the determined one or more topics.

In example embodiments, the method includes querying a database storing data associated with expiring events to determine whether the consumed event satisfies one or more criteria, generating a new notification event in response to the one or more criteria being satisfied, and processing the new notification event to generate the one or more notifications with the event platform.

The database for generating events related to expiry can be located on a cloud computing server separate from the event platform.

In example embodiments, to generate and transmit the one or more notifications, the method includes determining whether one or more notification criteria are satisfied and generating the one or more notifications in response to the notification criteria being satisfied.

In example embodiments, the method includes determining that at least some existing events associated of at least one of the one or more applications requires retrofitting and generating new events for the determined at least some existing events and post the new events to the respective outbox table for processing.

In example embodiments, at least two of the plurality of services generate events based on a single application of the one or more applications.

In example embodiments, the generated notification is generated by a notification service separate from the event platform.

In example embodiments, each of the one or more services is configured to independently post to respective outbox tables.

In example embodiments, the method includes, with an event service associated with the determined subscription topic, querying an enterprise database for notification information, and populating the one or more notifications with responses to the query, wherein the event service is implemented on a remote computing environment, and the enterprise database is on a private cloud of the enterprise.

In another aspect, a non-transitory computer readable medium (CRM) for generating notifications with customized event architectures is disclosed. The CRM includes computer executable instructions for providing a one or more applications, each application for processing a respective workflow with one or more services, and providing, for each service associated with the one or more applications, a database. The instructions are for configuring each of the one or more services to write events to respective databases. Each database can have a dedicated outbox table of events for that service. The instructions are for with an event platform: configuring a connector for consuming events to process events in the dedicated outbox tables and determining one or more subscription topics associated with the processed events. The instructions are for, based on the one or more determined subscription topics, generating, and transmitting one or more notifications, and posting transmission of the one or more notifications to another topic, the other topics being associated with the determined one or more topics.

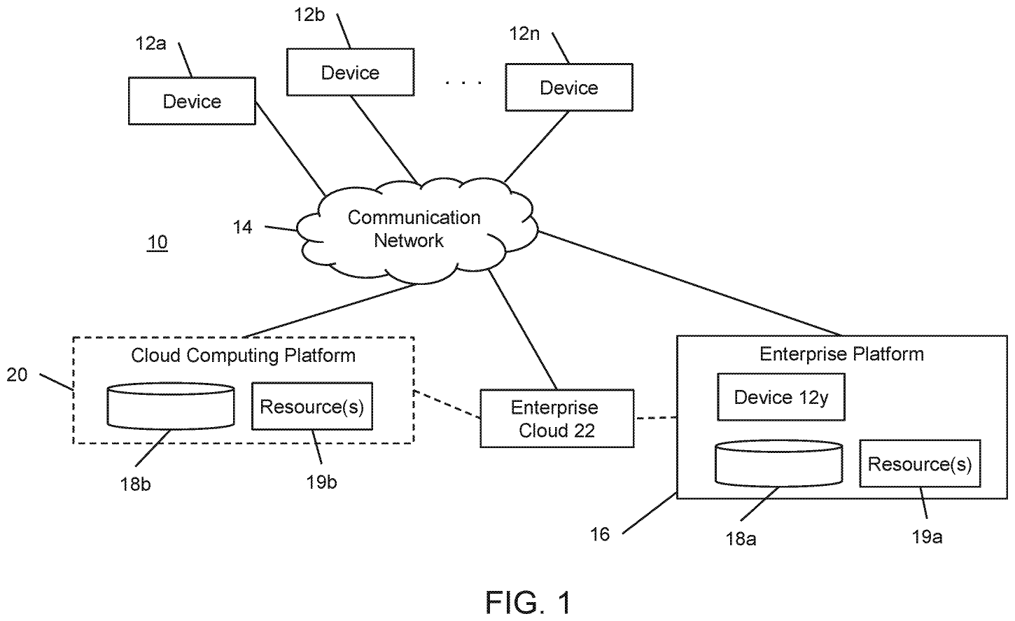

FIG. 1 illustrates an exemplary computing environment 10. The computing environment 10 can include one or more devices 12 for interacting with customized event architectures (as described herein), a communications network 14 connecting one or more components of the computing environment 10, an enterprise platform 16, a cloud computing platform 20, and, optionally, a cloud computing system 22 of the enterprise that is associated with the enterprise platform 16 (hereinafter referred to as an enterprise cloud 22, for ease of reference).

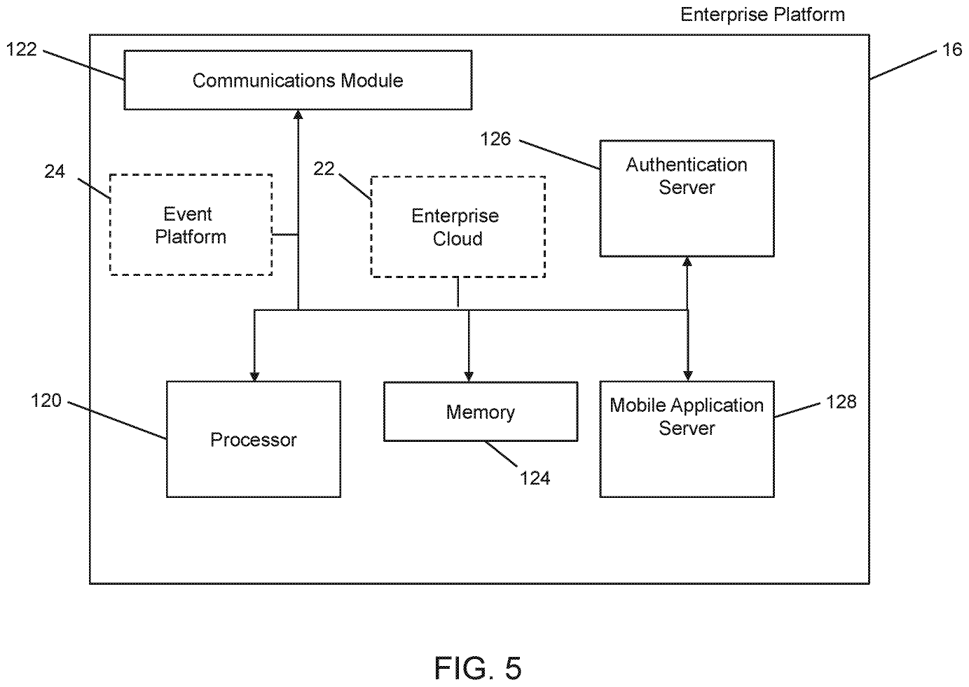

The enterprise platform 16 (e.g., a financial institution such as commercial bank and/or lender) stores data, in the shown example stored in a database 18a, that can be processed for one or more tasks (e.g., products or services). That data can be stored locally on the enterprise platform 16, stored on behalf of the enterprise platform on the cloud platform 20, or stored on the enterprise cloud 22. The enterprise platform 16 can provide a plurality of services or products via a plurality of enterprise resources (e.g., various instances of the shown database 18a, and/or computing resources 19a). While several details of the enterprise platform 16 have been omitted for clarity of illustration, reference will be made to FIG. 5 below for additional details.

The data the enterprise platform 16 is responsible for can be at least in part sensitive data (e.g., financial data, customer data, etc.), data that is not sensitive, or a combination of the two. This disclosure contemplates an expansive definition of data that is not sensitive, including, but not limited to factual data (e.g., environmental data), data generated by an organization (e.g., monthly reports, etc.), market data (e.g., mortgage rate offerings), etc. This disclosure contemplates an expansive definition of data that is sensitive, including client data, personally identifiable information, financial information, medical information, trade secrets, confidential information, etc.

The cloud computing platform 20 and enterprise cloud 22 can similarly include one or more instances of a database (e.g., a database 18b of platform 20), for example, for receiving event data, for providing event data to event services, for providing data needed to generate events, etc. Resources 19b of the cloud computing platform 20 can facilitate task performance for the enterprise, including generating events, evaluating whether an event belongs to a topic, etc. Hereinafter, for ease of reference, the resources 18, 19, of the respective platform 16 or 20 shall be referred to generally as resources, unless otherwise indicated.

It can be appreciated that while the enterprise platform 16, enterprise cloud 22, and cloud computing platform 20 are shown as separate entities in FIG. 1, they may also be implemented, run on, or otherwise be directed by a single enterprise. For example, the cloud computing platform 20 can be contracted by the enterprise platform 16 to provide certain event architecture for the enterprise platform 16, or the enterprise platform 16 can host certain sensitive functions or data required to generate notifications on the enterprise cloud 22 while other aspects are housed on the cloud platform 20, etc.

Devices 12 may be associated with one or more entities. Entities may be referred to herein as customers, clients, contractors, service providers, employees, management, correspondents, or other entities that interact with the enterprise platform 16, cloud computing platform 20, or enterprise cloud 22 (directly or indirectly). The computing environment 10 may include multiple devices 12, each device 12 being associated with a separate entity or associated with one or more entities. The devices can be external to the enterprise system (e.g., the shown devices 12a, 12b, to 12n), or internal to the enterprise platform 16 (e.g., the shown device 12y, which can be controlled by a customer service provider of the enterprise). In certain embodiments, an entity may operate device 12 such that device 12 performs one or more processes consistent with the disclosed embodiments. For example, the entity may use device 12a to submit a mortgage application that triggers the creation of an event in an outbox.

Devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

The enterprise platform 16, cloud computing platform 20, and/or enterprise cloud 22 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the cloud computing platform 20 and enterprise platform 16. The cryptographic server may, for example, be used to protect any data of the enterprise platform 16 when in transit to the cloud computing platform 20, or within the enterprise cloud 22 (e.g., data such as financial data and/or client data and/or transaction data within the enterprise) by way of encryption for data protection, digital signatures or message digests for data integrity, and by using digital certificates to authenticate the identity of the entities and devices 12 with which the enterprise platform 16, enterprise cloud 22, and/or cloud computing platform 20 communicates to generate notifications. It can be appreciated that various cryptographic mechanisms and protocols can be chosen and implemented to suit the constraints and requirements of the particular deployment of the cloud computing platform 20 or enterprise platform 16 as is known in the art.

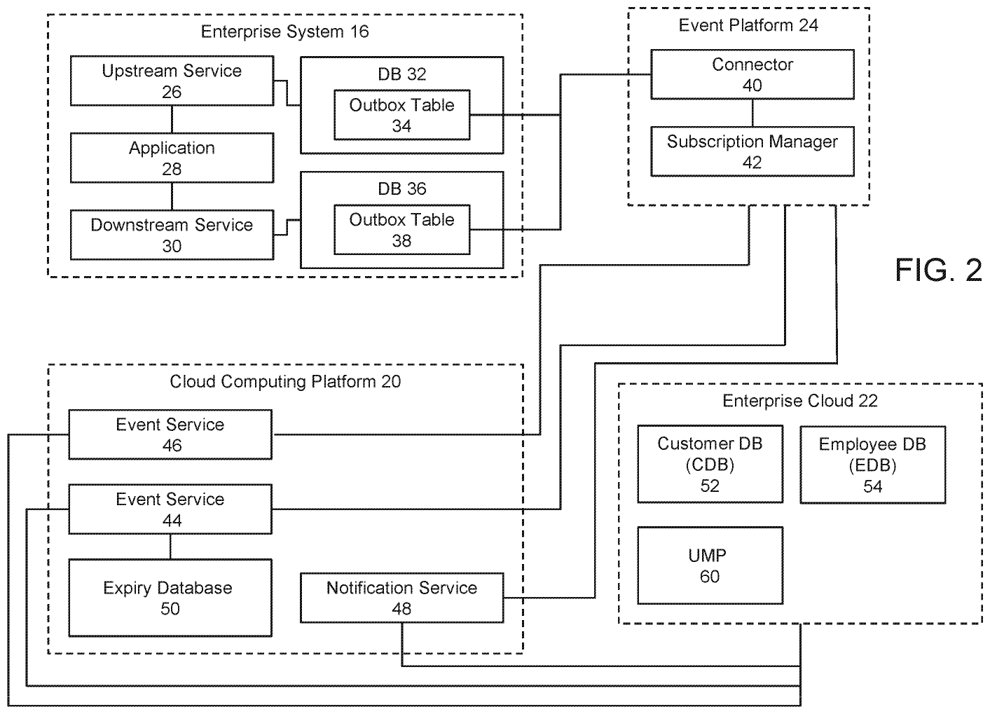

FIG. 2 shows a block diagram of an example workflow for generating notifications with customized event architectures, as disclosed herein.

The enterprise platform 16 can include a plurality of applications for managing the plurality of products or services offered by the enterprise. For example, in FIG. 2, the shown enterprise platform 16 includes a product application 28, although it is understood that a plurality of different applications can be hosted (at least in part) on the enterprise platform 16. In example embodiments, the product application 28 is an application to book a product with a rate offered by the enterprise (e.g., a mortgage, a loan, etc.).

The product application 28 can be in communication with one or more services upstream of the application 28 to operate. For example, in the shown embodiment, the product application 28 can rely on information from the upstream service 26, which can be a service that generates or provides inputs to the first product application 28 (e.g., the credit worthiness of a mortgage applicant), or a service that modifies events of existing products or services (e.g., a service that modifies all transactions/processes that make updates to a product managed by the application 28, such as mortgage application status change events, to call the application 28).

The product application 28 can also be in communication with one or more services downstream of the application 28. For example, in the shown embodiment, the product application 28 can communicate with the downstream service 30, which can be used to modify transaction workflows to write events to a dedicated database. For example, in at least some example embodiments, the downstream service 30 can be a credit database service which manages mortgage interest rates offered by the offering enterprise.

The product application 28, or one or more upstream and downstream services relied on by the product application 28 can be in communication with a separate, dedicated database to store events generated by the respective application or service. For example, in the shown embodiment, the upstream service 26 communicates with a dedicated database 32, having a dedicated and separate instance of an outbox table 34 for storing events generated by the upstream service 26 (e.g., all modifications are stored as a separate event in the outbox table 34). Similarly, the downstream service 30 can be in communication with a dedicated database 36, storing events generated by the downstream service 30 in an outbox table 38 (e.g., to write events for when a rate booking transaction has occurred).

Data stored in the outbox tables 34, 38 can be provided to the event platform 24. In the shown embodiment, the event platform 24 includes a connector 40, and a subscription manager 42. The event platform 24 can be hosted on one or more of the enterprise platform 16, the cloud computing platform 20, or the enterprise cloud 22, in whole or in part.

The connector 40 can be in communication with the plurality of dedicated outboxes (e.g., the shown tables 34, 38) to consume events of the outbox tables to create events that are compatible with the event platform 24. Various configurations of the connector 40 are contemplated, including a connector 40 with different protocols for ordering of processing events, etc. In example embodiments, the connector 40 can be a Kafka™ Java Database Connectivity (JDBC) connector. By having a dedicated database and/or outbox for each service associated with an application (e.g., application 28), the event processing accuracy can be increased as the outbox table records match the business event. Dedicated outbox tables can simplify the architecture with respect to producing events for applications to write in their own database, as compared to having events generated and integrated at the event platform level. In contrast to instances where a single outbox is used for the plurality of applications, with the described approach it can be easier to manage failures and retries of saving data in the event that the service or singular database is not available.

The subscription manager 42 can be used to determine which services downstream of the event platform 24 need to be notified of determined events. In example embodiments, the subscription manager 42 is configured with a one-to-many matching of events to subscribed downstream services, enabling flexibility in maintaining separate applications 28 or services that can impact multiple stakeholders within an enterprise. For example, an application handling mortgage applications can generate events that result in notifications to a broker and a customer.

The subscription manager 42 can be organized with various topics to which the downstream services are subscribed. For example, the subscription manager can determine the topic to which an event ingested by the connector 40 relates, and generate and transmit one or more notifications or events to the downstream services which are subscribed to the determined topic. In example embodiments, the event platform 24 can be an event platform based on the Kafka™ framework.

In the shown embodiment, as an example of possible downstream services, the cloud computing platform 20 includes a rate booking process event downstream service (RBES) 44. The RBES 44 can consume events assigned to the topic of rate booking events from the event platform 24, save event bookings to the expiry database 50 (as described herein), apply one or more criteria based on a related expiry date to events stored in the database 50 to determine whether to the event is about to expire, and if so, whether and to whom a notification should be provided to, etc. The RBES 44 can trigger the creation of notification events directly, by communicating with the notification service 48, or indirectly by generating new events for the event platform 24 to consume. The RBES 44 can orchestrate calls to other services or databases to determine appropriate contact details for the notification (e.g., determine contact information of a broker of record employee and customer contact information and preferences (e.g., an email address, a preference for SMS communication, etc.)). For example, the RBES 44 can communicate with the database 50 to determine that a booked rate is about to expire and provide an expiry event to the event platform 24 to notify relevant subscribed services (e.g., the notification service 48).

In another example, in the shown embodiment the cloud computing platform 20 includes a mortgage process event service (MPES) 46. The MPES 46 can consume events denoted by the topic mortgage application events from the event platform 24, similarly apply one or more criteria (e.g., business rules), where, for example, the criteria can be based on a related expiry date to events stored in the database 50 to determine whether to the event is about to expire, and if so, whether and to whom a notification should be provided to. The MPES 46 can trigger the creation of notification events directly, by communicating with the notification service 48, or indirectly by generating new events for the event platform 24 to consume. The MPES 46 can orchestrate calls to other services or databases to determine appropriate contact details for the notification (e.g., determine a broker of record employee contact information and customer contact information and preferences (e.g., an email address, a preference for SMS communication, etc.).

In another example, in the shown embodiment the cloud computing platform 20 includes a notification alert service (NOES) 48. The NOES 48 can consume events assigned to the topic of notification by the event platform 24. The NOES 48 can invoke a messaging platform, such as the shown universal messaging platform (UMP) 60 to send alert notifications to employees and/or customers.

The services downstream of the event platform 24 can also include one or more databases to track expiring events. For example, the shown expiry database 50 can be used to maintain data about expiring events such as a rate expiration (e.g., a mortgage interest rate). The expiry database 50 can be a structured query language (SQL) database.

Each of the services 44, 46, and 48 can be registered with the event platform 24 as both producers of, and subscribers to, events. For example, the NOES 48 can produce events to retry a notification in the event of failure. In an example embodiment, if the retry event has already been provided to the event platform 24, the NOES 48 can be configured to periodically poll the event platform 24 to determine if any retry topic events have been consumed, and if not, attempt to complete the notification.

In the shown embodiment, services downstream of the event platform 24 are shown as being hosted by the cloud computing platform 20. It is understood that this example is illustrative, and that the services downstream of the event platform 24 can be hosted on, for example, the cloud enterprise 22.

The services 44, 46, 48 can be in communication with one or more computing resources (e.g., sensitive resources), stored in the enterprise cloud 22 to complete one or more tasks. For example, the RBES 44 can be in communication with a customer database (CDB) 52 to determine customer contact information (e.g., based on a customer ID). In another example, the MPES 46 can be in communication with an employee database (EDB) 54 to determine an employee associated with a mortgage. The NOES 48 can be in communication with a UMP 60, which can be an enterprise-controlled messaging protocol for sending sensitive messages to ensure confidential information is not misused.

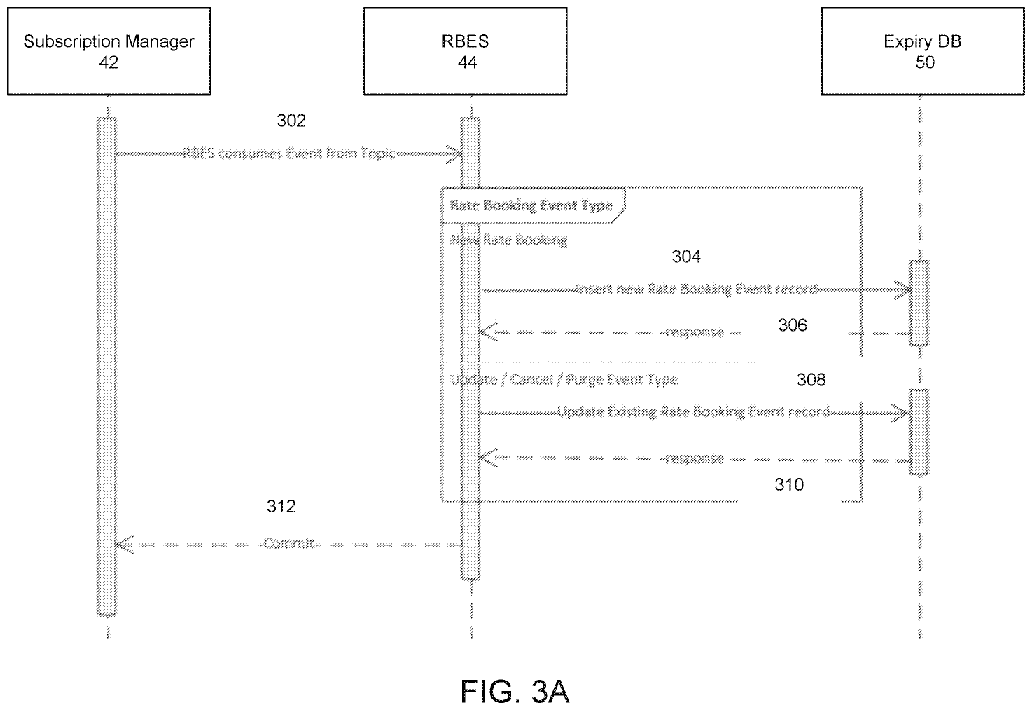

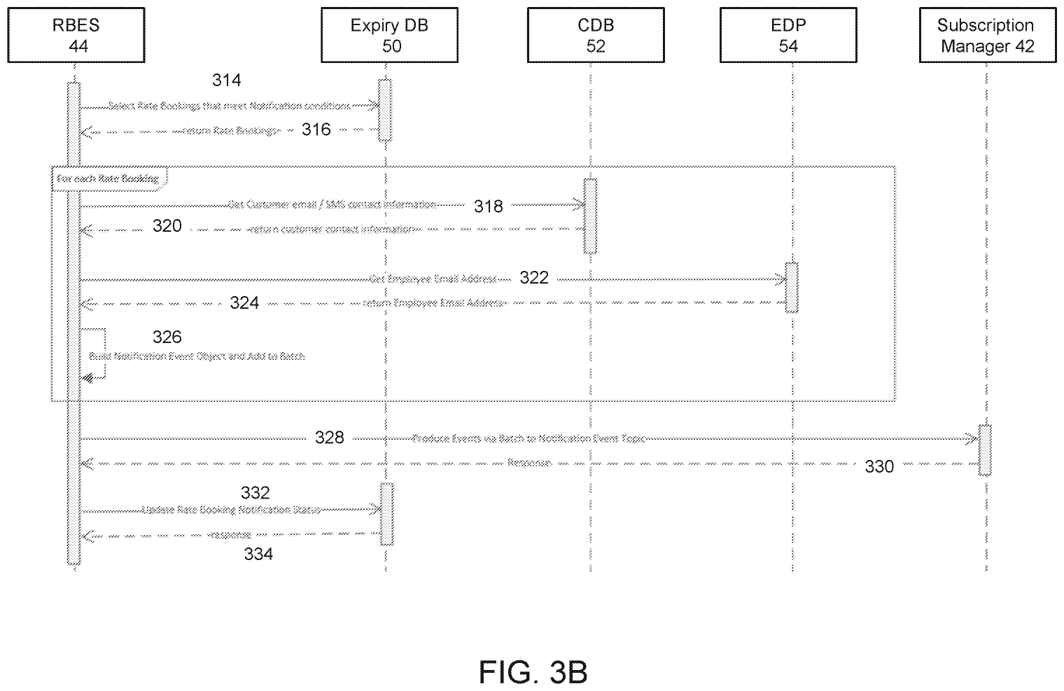

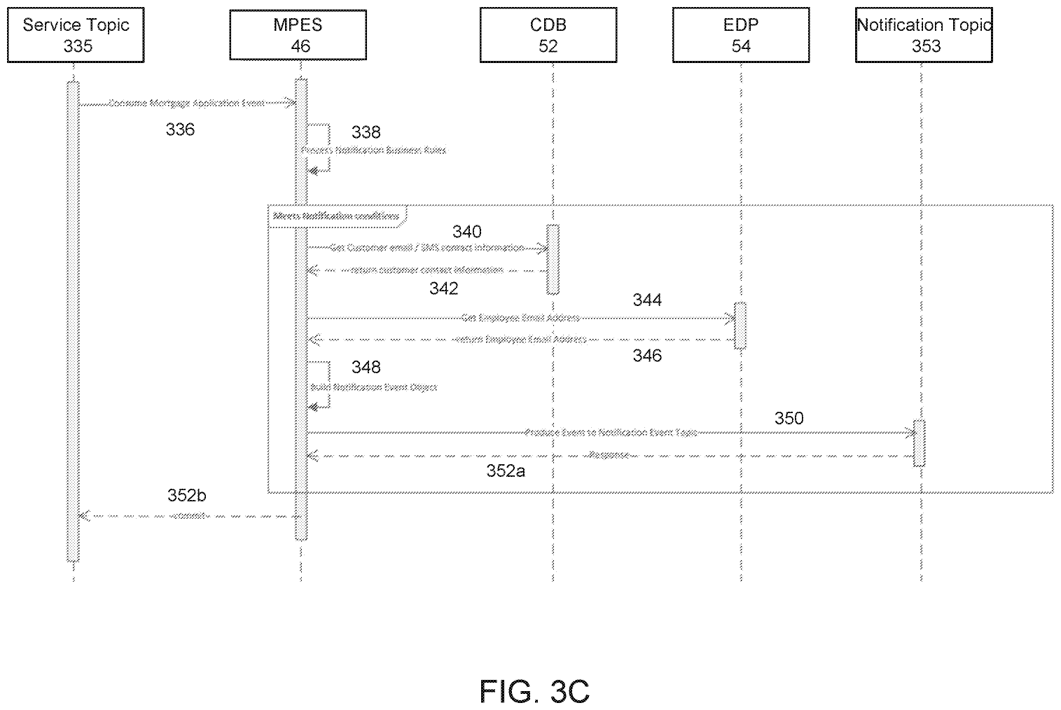

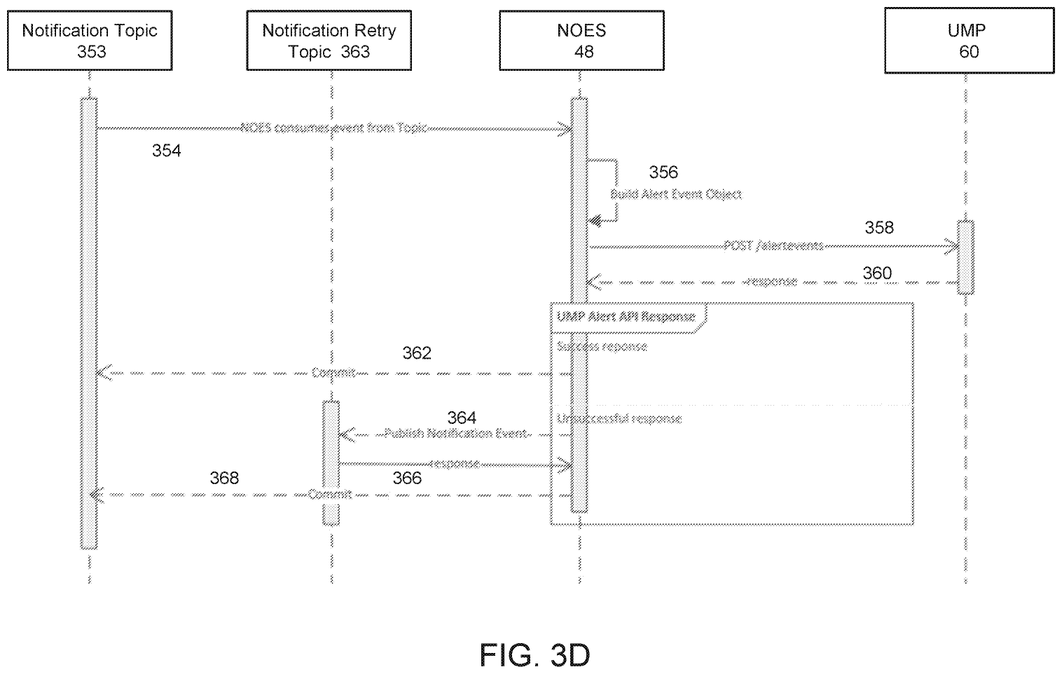

Referring now to FIGS. 3A, 3B, 3C, and 3D, each shows a block diagram of an example aspect of a workflow for generating notifications with customized event architectures.

In FIG. 3A, an example workflow for generating an entry into the expiry database 50 is shown. At flow 302, the RBES 44 consumes as event from the topics maintained by the subscription manager 42, such as a new rate booking event.

At flow 304, the RBES 44 creates a new event record in the expiry database 50. For example, continuing the new rate booking event example, the RBES 44 can populate the expiry database 50 event with a booking ID, an expiry date, a status, etc.

At flow 306, the database 50 can respond with confirmation that the event has been created.

At flow 308, if an update event associated with an existing record in the expiry database 50 is received by the RBES 44, the RBES 44 can provide the expiry database 50 with a message to update related existing records. In example embodiments, the RBES 44 provides all events with information related to expiries to the expiry database 50, and the expiry database 50 determines whether to update an event. For example, the expiry database 50 can provide confirmation, in flow 310, as to whether the update has been processed.

At flow 312, the RBES 44 messages the subscription manager 42 to commit to the changes. For example, the RBES 44 can confirm that the event has been successfully consumed and remove it from the topic which led to the event being provided to the RBES 44.

FIG. 3B shows a flow diagram of an example workflow to consume a rate booking notification event.

At flow 314, the RBES 44 can query the expiry database 50 to return records that respond to one or more criteria. For example, the criteria can be based on a time to expiry, a degree of change to the rate since the rate was first booked, whether a rate belongs to a particular customer, a business rule, etc.

At flow 316, the expiry database 50 can respond with records that satisfy the criteria.

At flow 318, for each record responsive to the rate criteria, the RBES 44 can query the CBD 52 to determine customer contact information (provided via response shown as flow 320). Similarly, at flow 322, for each record responsive to the rate criteria, the RBES 44 can query the EBD 54 to determine employee contact information (provided via response shown as flow 324).

The contact information can include contact information (e.g., email address, phone number), contact preferences such as a communication channel, a preferred time, etc.

At flow 326, the RBES 44 generates a new event at least in part based on the information received in flow 320 and/or flow 324. At flow 328, the RBES 44 transmits the new event to the subscription manager for inclusion in the relevant topic (e.g., a notification). At flow 330, the RBES 44 can receive a response as to whether the transmission and inclusion in the topic has been successful.

At flow 332, the RBES 44 can update the expiry database 50 with an indication as to whether the notification event was successfully published. Flow 332 can include the RBES 44 updating the status of the event, for example if a multiple reminder notification approach is in use. At flow 334, the RBES 44 receives confirmation from the database 50.

Referring now to FIG. 3C, a flow diagram of an example workflow to consume and process mortgage application events is shown.

Block 335 denotes a topic managed by the subscription manager 42. In the shown embodiment, the block 335 denotes a mortgage application event.

At flow 336, the MPES 46 consumes events in the topic denoted by block 335.

At flow 338, the MPES 46 determines whether one or more criteria apply to the consumed event. The criteria can include, for example, criteria to determine whether a notification is required. In at least some example embodiments, the criteria can include whether a property (e.g., a rate) associated with the event is about to expire (e.g., a mortgage product can be quoted with an initial rate, in advance of an agreement of purchase and sale, where the initial rate expires after a certain amount of time), whether a more favorable rate is available, whether any relevant promotions are available, etc.

At flow 340, in response to determining that the notification criteria of flow 338 are satisfied, the MPES 46 queries for and receives customer contact information (the shown flows 340, 342), queries for and receives employee contact information (the shown flows 344, 346). At flow 348, the MPES 46 generates a notification event for topic 353, similar to flow 326.

At flow 350, the MPES 46 transmits the event to a topic 353 managed by the subscription manager 42. The subscription manager 42 can confirm receipt of the event (shown as flow 352a), and mark the originating event as consumed (flow 352b).

Referring now to FIG. 3D, a flow diagram of an example workflow to process notification alerts is shown.

At flow 354, the NOES 48 consumes an event from the notification topic 353. At flow 356, the NOES 48 builds an alert event object that is capable of being ingested by the UMP 60 based on the notification event.

At flow 358, the NOES 48 posts the event generated in flow 356 to the UMP 60, and a response is received in flow 360.

In response to determining that the notification was successfully delivered (e.g., flow 360 is received), the NOES 48 can notify the subscription manager 42 that the originating event from the topic 353 was consumed, as shown in flow 362.

In response to determining that the notification was not successfully delivered, at flow 364, the NOES 48 can create an event and assign the created event to the retry notification topic (shown as flow 363). The subscription manager 42 can respond in flow 366 to indicate that the event of flow 364 was successfully received or registered.

At flow 368, the NOES 48 can commit to the originating event being consumed from the topic 353, leaving only the event in the retry topic 363.

It is understood that the sequences shown in FIGS. 3A, 3B, 3C, and 3D are illustrative, and not limiting. For example, flows 340, 342 can occur after flows 344, 346. It is also understood that the sequences shown in FIGS. 3A, 3B, 3C, and 3D can be in whole or at least in part automated. For example, the sequences can be wholly automated, such that the event notification does not require input from an individual.

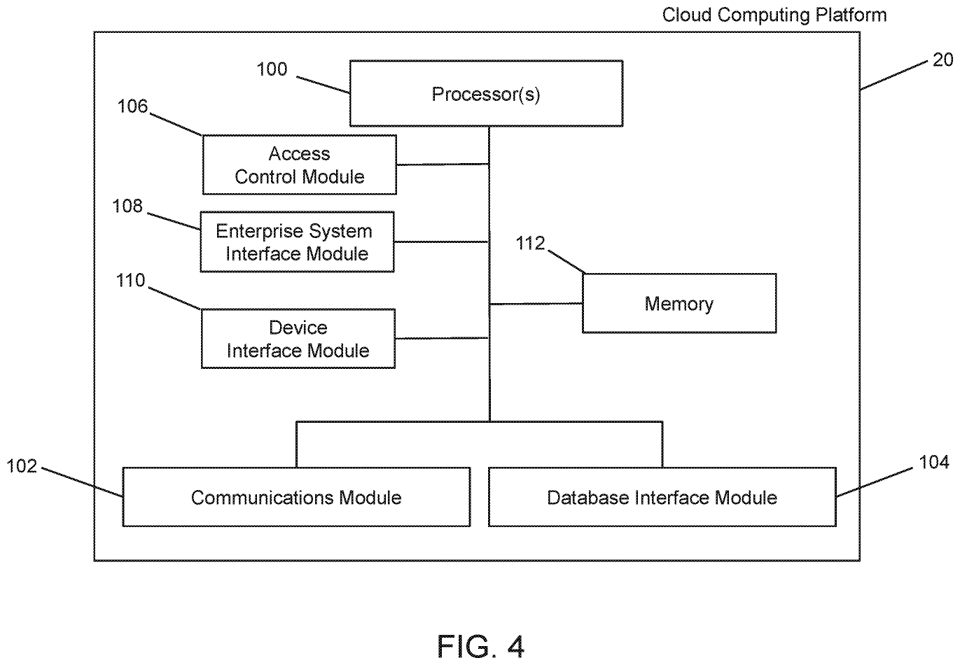

Referring now to FIG. 4, a block diagram of an example configuration of a cloud computing platform 20 is shown. FIG. 4 illustrates examples of modules, tools and engines stored in memory 112 on the cloud computing platform 20 and operated or executed by the processor 100. It can be appreciated that any of the modules, tools, and engines shown in FIG. 4 may also be hosted externally and be available to another cloud computing platform 20, e.g., via the communications module 102.

In the example embodiment shown in FIG. 4, the cloud computing platform 20 includes a database interface module 104, an enterprise system interface module 108, and a device interface module 110.

The database interface module 104 can be used for communicating with different instances of the database 18a. For example, a direct communication between the cloud platform 20 and the market data database 18 can be established via the database interface module 104.

An access control module 106 may be used to apply a hierarchy of permission levels or otherwise apply predetermined criteria to determine what aspects of the cloud computing platform 20 can be accessed by devices 12, what resources 18b, 19b, the platform 20 can provide access to, and/or how related data can be shared with which entity in the computing environment 10. For example, the cloud computing platform 20 may grant certain employees of the enterprise platform 16 access to only certain resources 18b, 19b, but not other resources. As such, the access control module 106 can be used to control the sharing of resources 18b, 19b or aspects of the platform 20 based on a type of client/user, a permission or preference, or any other restriction imposed by the enterprise platform 16, the computing environment 10, or application in which the cloud computing platform 20 is used.

The enterprise system interface module 108 can provide a graphical user interface (GUI), software development kit (SDK) or API connectivity to communicate with the enterprise platform 16. It can be appreciated that the enterprise system interface module 108 may also provide a web browser-based interface, an application or “app” interface, a machine language interface, etc. Similarly, the device interface module 110 can provide a GUI, SDK, or API connectivity to communicate with devices 12. The database interface module 104 can facilitate direct communication with database 18a, or other instances of database 18 stored on other locations of the enterprise platform 16.

In FIG. 5, an example configuration for an enterprise platform 16 is shown. In certain embodiments, similar to the cloud computing platform 20, the enterprise platform 16 may include one or more processors 120, a communications module 122, and a database interface module (not shown) for interfacing with the remote or local datastores to retrieve, modify, and store (e.g., add) data to the resources 18a, 19a. Communications module 122 enables the enterprise platform 16 to communicate with one or more other components of the computing environment 10, such as the cloud computing platform 20 (or one of its components), the enterprise cloud 22, via a bus or other communication network, such as the communication network 14. The enterprise platform 16 can include at least one memory or memory device 124 that can include a tangible and non-transitory computer-readable medium having stored therein computer programs, sets of instructions, code, or data to be executed by processor 120. FIG. 5 illustrates examples of modules, tools and engines stored in memory on the enterprise platform 16 and operated or executed by the processor 120. It can be appreciated that any of the modules, tools, and engines shown in FIG. 5 may also be hosted externally and be available to the enterprise platform 16, e.g., via the communications module 122. In the example embodiment shown in FIG. 5, the enterprise platform 16 includes at least part of the enterprise cloud 22, an event platform 24 (e.g., to automate notification generation), an authentication server 126, for authenticating entities to access resources 18a, 19a, of the enterprise, and a mobile application server 128 to facilitate a mobile application that can be deployed on mobile devices 12. The enterprise platform 16 can include an access control module (not shown), similar to the cloud computing platform 20.

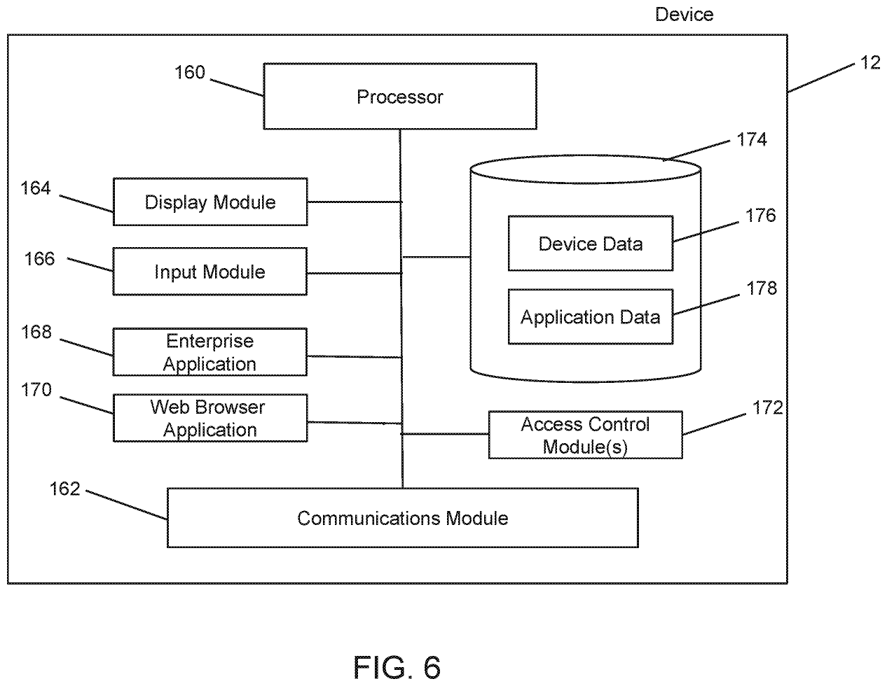

In FIG. 6, an example configuration of a device 12 is shown. In certain embodiments, the device 12 may include one or more processors 160, a communications module 162, and a data store 174 storing device data 176 (e.g., data needed to authenticate with a cloud computing platform 20 to perform ingestion), an access control module 172 similar to the access control module of FIG. 4, and application data 178 (e.g., data to enable communicating with the enterprise platform 16 to enable transferring of database 18a to the cloud computing platform 20). Communications module 162 enables the device 12 to communicate with one or more other components of the computing environment 10, such as cloud computing platform 20, or enterprise platform 16, via a bus or other communication network, such as the communication network 14. While not delineated in FIG. 6, similar to the cloud computing platform 20 the device 12 includes at least one memory or memory device that can include a tangible and non-transitory computer-readable medium having stored therein computer programs, sets of instructions, code, or data to be executed by processor 160. FIG. 6 illustrates examples of modules and applications stored in memory on the device 12 and operated by the processor 160. It can be appreciated that any of the modules and applications shown in FIG. 6 may also be hosted externally and be available to the device 12, e.g., via the communications module 162.

In the example embodiment shown in FIG. 6, the device 12 includes a display module 164 for rendering GUIs and other visual outputs on a display device such as a display screen, and an input module 166 for processing entity or other inputs received at the device 12, e.g., via a touchscreen, input button, transceiver, microphone, keyboard, etc. The device 12 may also include an enterprise application 168 provided by the enterprise platform 16, e.g., for generating events. The device 12 in this example embodiment also includes a web browser application 170 for accessing Internet-based content, e.g., via a mobile or traditional website and one or applications (not shown) offered by the enterprise platform 16 or the cloud computing platform 20. The data store 174 may be used to store device data 176, such as, but not limited to, an IP address or a MAC address that uniquely identifies device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 4 to 6 for ease of illustration and various other components would be provided and utilized by the cloud computing platform 20, enterprise platform 16, and device 12, as is known in the art. It can be appreciated that the modules, tools, and engines of the cloud platform 20 and the enterprise platform 20 shown in FIG. 2 have been omitted from FIGS. 4 and 5, for visual clarity.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in cloud computing platform 20 or enterprise platform 16, or device 12, or accessible or connectable thereto. Any application or module herein described may be implemented using computer readable/executable instructions that may be stored or otherwise held by such computer readable media.

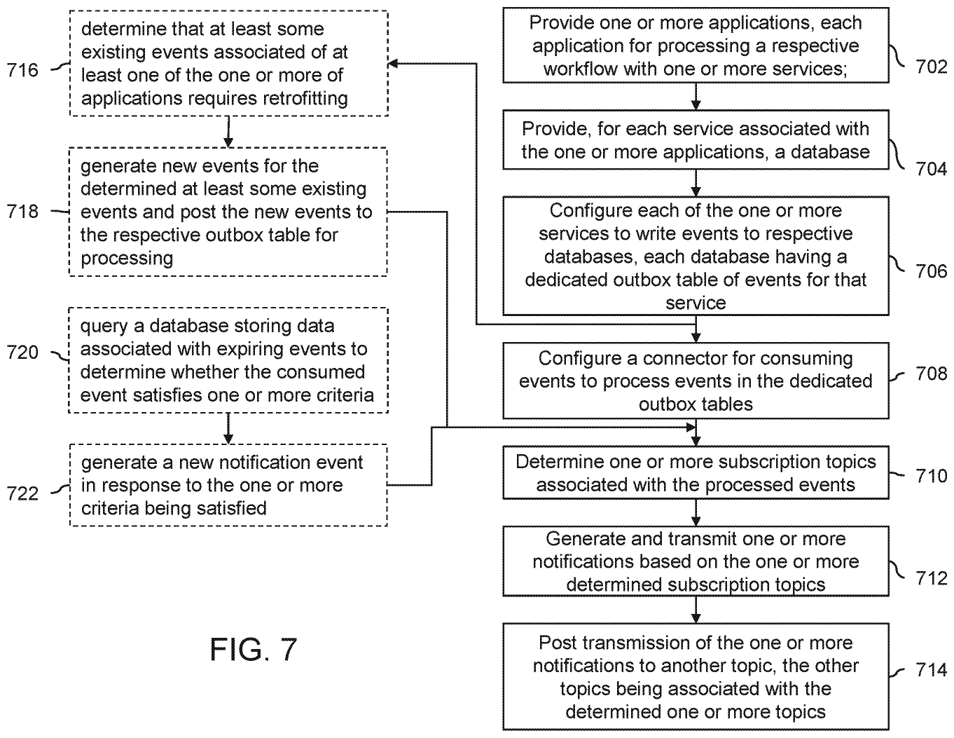

Referring to FIG. 7, a flow diagram of an example method performed by computer executable instructions for generating notifications with customized event architectures is shown. It is understood that reference to the preceding figures is illustrative only, and not limiting.

At block 702, one or more applications (e.g., application 28) are provided. Each of the applications is for processing a respective workflow (e.g., a mortgage application) with one or more services (e.g., services 26, 30).

At block 704, each of the services associated with the one or more applications is provided with a database (e.g., DB 32, 36). The databases can be separate and distinct from one another at least in that the respective service (e.g., services 26, 30) is able to write to the respective database outbox table without restriction.

At block 706, the one or more services are configured to write events to their respective database. Each database has a dedicated outbox table (e.g., a box table 34, 38).

At block 708, a connector (e.g., connector 40) is configured to process events in each of the dedicated outbox tables. The connector 40 can consume the events by providing them to the subscription manager 42.

At block 710, one or more subscription topics (e.g., topics managed by the subscription manager 42) associated with events processed by the connector in block 708 are determined. For example, the event can be a mortgage application, a credit application, etc. In at least some example embodiments, the events that are processed include at least one property which expires.

At block 712, one or more notifications are generated and transmitted based on the determined subscription topics. For example, referring illustratively to FIG. 3C, the generated notification can be the notification generated in flow 350.

At block 714, transmission of the one or more notifications can be posted to another topic. For example, again referring to FIG. 3C, flow 352b shows an example of the posting where the one or more notification has been provided to notification topic 353, and as a result the topic 335 can be updated to consume the relevant event.

What follows is a discussion of some optional embodiments.

At block 716, it can be determined that at least some existing events associated with at least one application require retrofitting. For example, previous mortgage applications can be onboarded to the disclosed event architecture to generate notifications.

At block 718, new events for the determined at least some existing events can be generated and posted as events to the respective outcome tables for processing. Existing systems can therefore potentially be retrofitted to take advantage of the disclosed event architecture.

At block 720, a database storing data associated with expiring events (e.g., database 50) can be queried to determine whether the events stored in the database satisfy one or more criteria. As alluded to above, the criteria can include expiry related criteria, and other criteria.

At block 722, a new notification event can be generated for each of the events in the database 50 that satisfies the asserted criteria. An illustrative example is provided in FIG. 3B.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A system for generating notifications with customized event architectures, the system comprising:
a processor;
a communications module coupled to the processor; and
a memory coupled to the processor, the memory storing computer executable instructions that when executed by the processor cause the processor to:
provide one or more applications, each application for processing a respective workflow with one or more services;
provide, for each service associated with the one or more applications, a database;
configure each of the one or more services to write events to respective databases, each database having a dedicated outbox table of events for that service;
with an event platform:
configure a connector for consuming events to process events in the dedicated outbox tables;
determine one or more subscription topics associated with the processed events;
based on the one or more determined subscription topics, generate and transmit one or more notifications; and
post transmission of the one or more notifications to another topic, the other topic being associated with the determined one or more topics.

2. The system of claim 1, wherein the instructions cause the processor to:
query a database storing data associated with expiring events to determine whether expired events satisfy one or more criteria;
generate a new notification event in response to the one or more criteria being satisfied; and
process the new notification event to generate the one or more notifications with the event platform.

3. The system of claim 2, wherein the database for generating events related to expiry is located on a cloud computing server separate from the event platform.

4. The system of claim 1, wherein, to generate and transmit the one or more notifications, the instructions cause the processor to:
determine whether one or more notification criteria are satisfied; and
generate the one or more notifications in response to the notification criteria being satisfied.

5. The system of claim 1, wherein the instructions cause the processor to:
determine that at least some existing events associated of at least one of the one or more applications requires retrofitting; and
generate new events for the determined at least some existing events and post the new events to the respective outbox table for processing.

6. The system of claim 1, wherein at least two of the plurality of services generate events based on a single application of the one or more applications.

7. The system of claim 1, wherein the generated notification is generated by a notification service separate from the event platform.

8. The system of claim 1, wherein each of the one or more services is configured to independently post to the dedicated outbox table.

9. The system of claim 1, wherein the instructions cause the processor to:
with an event service associated with the determined subscription topic:
query an enterprise database for notification information; and
populate the one or more notifications with responses to the query.

10. The system of claim 9, wherein the event service is implemented on a remote computing environment, and the enterprise database is implemented on a private cloud of the enterprise.

11. A method for generating notifications with customized event architectures, the method comprising:
providing a one or more applications, each application for processing a respective workflow with one or more services;
providing, for each service associated with the one or more applications, a database;
configuring each of the one or more services to write events to respective databases, each database having a dedicated outbox table of events for that service;
with an event platform:
configuring a connector for consuming events to process events in the dedicated outbox tables;
determining one or more subscription topics associated with the processed events;
based on the one or more determined subscription topics, generating and transmitting one or more notifications; and
posting transmission of the one or more notifications to another topic, the other topic being associated with the determined one or more topics.

12. The method of claim 11, further comprising:
querying a database storing data associated with expiring events to determine whether expired events satisfy one or more criteria;
generating a new notification event in response to the one or more criteria being satisfied; and
processing the new notification event to generate the one or more notifications with the event platform.

13. The method of claim 12, wherein the database for generating events related to expiry is located on a cloud computing server separate from the event platform.

14. The method of claim 11, wherein, to generate and transmit the one or more notifications, the method comprises:
determining whether one or more notification criteria are satisfied; and
generating the one or more notifications in response to the notification criteria being satisfied.

15. The method of claim 11, further comprising:
determining that at least some existing events associated of at least one of the one or more applications requires retrofitting; and
generating new events for the determined at least some existing events and post the new events to the respective outbox table for processing.

16. The method of claim 11, wherein at least two of the plurality of services generate events based on a single application of the one or more applications.

17. The method of claim 11, wherein the generated notification is generated by a notification service separate from the event platform.

18. The method of claim 11, wherein each of the one or more services is configured to independently post to respective outbox tables.

19. The method of claim 11, further comprising:
with an event service associated with the determined subscription topic, querying an enterprise database for notification information, and populating the one or more notifications with responses to the query,
wherein the event service is implemented on a remote computing environment, and the enterprise database is implemented on a private cloud of the enterprise.

20. A non-transitory computer readable medium for generating notifications with customized event architectures, the computer readable medium comprising computer executable instructions for:
providing a one or more applications, each application for processing a respective workflow with one or more services;
providing, for each service associated with the one or more applications, a database;
configuring each of the one or more services to write events to respective databases, each database having a dedicated outbox table of events for that service;
with an event platform:
configuring a connector for consuming events to process events in the dedicated outbox tables;
determining one or more subscription topics associated with the processed events;
based on the one or more determined subscription topics, generating and transmitting one or more notifications; and
posting transmission of the one or more notifications to another topic, the other topic being associated with the determined one or more topics.
